(19) United States
(12) Patent Application Publication
(10) Pub. No.: US 2022/0092651 A1
(43) Pub. Date: Mar. 24, 2022

(54) SYSTEM AND METHOD FOR AN AUTOMATIC, UNSTRUCTURED DATA INSIGHTS TOOLKIT

(71) Applicant: Palo Alto Research Center Incorporated, Palo Alto, CA (US)

(72) Inventors: Karunakaran Sureshkumar, Los Angeles, CA (US); Jesse Vig, Los Altos, CA (US); Kyle D. Dent, San Carlos, CA (US)

(73) Assignee: Palo Alto Research Center Incorporated, Palo Alto, CA (US)

(21) Appl. No.: 17/029,683

(22) Filed: Sep. 23, 2020

(51) Int. Cl. G06Q 30/02; G06Q 30/06; G06F 40/30

(52) U.S. Cl. CPC G06Q 30/0282; G06F 40/30; G06Q 30/0627

(57) ABSTRACT

A system is provided to receive a request for insights based on reviews for a product, wherein the request includes information input by a user relating to configuration information, calibration information, and desired feature information, and wherein the configuration information includes a relevance weight for at least one of a plurality of attributes for each review. The system assigns, based on the relevance weight, a normalized relevance weight for each review. The system generates, by a trained model based on the user-input information and the normalized relevance weight, quantitative and qualitative insights for the reviews. The system displays the quantitative and qualitative insights. The system modifies, by the user, a rating of a displayed qualitative insight term. The system executes the trained model based on the modified rating, and generates and displays updated quantitative and qualitative insights for the reviews.

### BACKGROUND

### Field

This disclosure is generally related to artificial intelligence. More specifically, this disclosure is related to a system and method for an automatic, unstructured data insights toolkit.

### Related Art

Today, companies may track user perception of their products and generate insights which can be used to make decisions, e.g., to improve or modify the products and to design future products. One current manner of obtaining the user perception is via online surveys. A company can design, run/administer, and analyze the results of these online surveys. However, obtaining user perception via online surveys can be subject to limitation. For example, creating, administering, and analyzing surveys can be time consuming. Survey results may be prone to response biases. In a portfolio with a very large number of products, it may not be feasible to survey all the products. Furthermore, surveys cannot provide historical data if a survey was not administered during a past time period of interest. In addition, surveys may be designed for a specific set of insights via a specific set of questions, which can result in missing certain insights based on questions which were not included the survey.

Thus, while surveys can provide user perception regarding products or other items, some challenges remain in effectively and efficiently obtaining the user perception, and, as a result, in modifying or designing future products based on the user perception.

### SUMMARY

The embodiments described herein provide a system and method for facilitating insight extraction. During operation, the system receives, by a first computing device, a request for insights based on reviews for a product, wherein the request includes information input by a user relating to configuration information for the reviews, calibration information including ratings of predetermined phrases, and desired feature information, and wherein the configuration information includes a relevance weight for at least one of a plurality of attributes for each review. The system assigns, based on the relevance weight for the at least one attribute, a normalized relevance weight for each review. The system filters the reviews based on a context associated with each review. The system generates, by a trained model running on the first computing device based on the user-input information and the normalized relevance weight, quantitative and qualitative insights for the filtered reviews. The system displays on a display screen of a computing device associated with the user, the quantitative insights based on a rating system. The system displays, on the display screen, the qualitative insights as a first set of terms categorized as positive insights and a second set of terms categorized as negative insights. The system modifies, by the user via graphical user interface elements on the display screen, a rating of a displayed qualitative insight term. The system executes the trained model based on the modified rating, which causes the first computing device to generate and display updated quantitative and qualitative insights for the filtered reviews.

In some embodiments, prior to receiving the request for insights, the system receives a stream of text data relating to the reviews for the product, wherein a review represents a reviewer opinion of the product, and the system parses the stream of text data to generate a table, wherein a row in the table indicates the reviewer opinion of the product, and wherein a column in the table indicates the attributes of the reviewer opinion.

In some embodiments, the user-input information is obtained by one or more of: displaying, on the display screen, graphical user interface elements which allow the user to enter, view, modify, and save the configuration information, wherein the configuration information includes the relevance weight for the at least one attribute for each review and further includes a name and a type for the plurality of attributes for each review; displaying, on the display screen, graphical user interface elements which allow the user to enter, view, modify, and save the calibration information, wherein the user-input ratings of the predetermined phrases are based on the rating system; and displaying, on the display screen, graphical user elements which allow the user to enter, view, modify, and save the desired feature information, wherein the desired feature information includes terms of interest in the reviews for the product.

In some embodiments, the trained model is a pretrained sequence model which includes two additional layers, including: an aspect mention detection layer which comprises a sequence labeling and classification layer that assigns tags identifying occurrences of terms; and a sentiment detection layer which comprises a token or span-level classifier or regression model that predicts a sentiment associated with an occurrence of a term.

In some embodiments, generating the quantitative and qualitative insights for the filtered reviews is further based on the user-input terms of interest, which comprises: detecting, in a respective review based on the trained model, a first occurrence of a first term and a first sentiment associated with the first occurrence of the first term.

In some embodiments, generating the quantitative and qualitative insights for the filtered reviews is further based on additional feature information identified by the first computing device and not included in the user-input terms of interest. The system identifies the additional feature information by the following operations. The system trains an aspect-independent version of the model, wherein the aspect-independent version does not include a feature name as an input feature. The system predicts, based on the aspect-independent version of the model, second occurrences of terms in reviews. The system identifies, based on the aspect-independent version of the model, third occurrences of terms which are not predicted by the trained model as candidate terms for discovery. The system clusters embeddings of the identified third occurrences.

In some embodiments, the system generates the quantitative and qualitative insights for the filtered reviews further based on the user-input calibration information, which comprises adjusting a threshold and a scale of sentiment specific to the user by fine-tuning a subset of parameters in a final layer of the trained model based on new labeled examples.

In some embodiments, the system filters the reviews based on the context associated with each review by determining, by the trained model, whether a review is relevant based on a binary classification.

In some embodiments, the system generates the quantitative insights for the filtered reviews by computing an aggregate sentiment score for each term based on the user-input relevance weight for the attributes across the reviews.

In some embodiments, the system generates the qualitative insights for the filtered reviews by aggregating occurrences of the terms in the filtered reviews and sentiments associated with the terms, by computing a first count of a number of occurrences of a term categorized as a positive insight and a second count of a number of occurrences of a term categorized as a negative insight. The system computes the first count and the second count based on the user-input relevance weight for the attributes across the reviews.

In some embodiments, the system executes the trained model based on the modified rating by training the model based on corrections to model predictions and corrected labels.

### BRIEF DESCRIPTION OF THE FIGURES

FIG. 1A illustrates an exemplary environment for facilitating insight extraction, in accordance with an embodiment of the present application.

FIG. 1B illustrates an exemplary environment for facilitating insight extraction, in accordance with an embodiment of the present application.

FIG. 2A illustrates exemplary reviews for a product, including opinion attributes to be used in an opinion parsing module, in accordance with an embodiment of the present application.

FIG. 2B illustrates an exemplary process for opinion parsing, in accordance with an embodiment of the present application.

FIG. 3 illustrates an exemplary graphical user interface for an opinion type setup, in accordance with an embodiment of the present application.

FIG. 4 illustrates an exemplary graphical user interface for an opinion calibration, in accordance with an embodiment of the present application.

FIG. 5 illustrates an exemplary graphical user interface for aspect entry, in accordance with an embodiment of the present application.

FIG. 6A illustrates an exemplary graphical user interface which displays quantitative and qualitative insights for reviews for a product, including interactive graphical user interface elements, in accordance with an embodiment of the present application.

FIG. 6B illustrates an exemplary graphical user interface which displays quantitative and qualitative insights for reviews for a product, including interactive graphical user interface elements which allow the user to override system-determined ratings and to rerun the model, in accordance with an embodiment of the present application.

FIG. 7 presents a flow chart illustrating a method for extracting insights associated with reviews for a product, in accordance with an embodiment of the present application.

FIG. 8 illustrates an exemplary distributed computer and communication system that facilitates insight extraction, in accordance with an embodiment of the present application.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

The embodiments described herein provide a system which effectively and efficiently extracts insights on user perception regarding product or other items, by using an automatic, unstructured data insights toolkit, rather than relying on cumbersome, biased, and potentially inaccurate online surveys.

As described above, companies may track user perception of their products and generate insights which can be used to make decisions, e.g., to improve or modify the products and to design future products. One current manner of obtaining the user perception is via online surveys. A company can design, run/administer, and analyze the results of the online surveys. One benefit of the online surveys is that they are controlled studies which can be designed by market research professionals to ensure response quality. Another benefit is that the online surveys can target a specific demographic and answer specific questions, such as “Why is the phone not performing well with females in the age group 21-20,” “Why is the phone doing so well in Los Angeles,” etc. Yet another benefit is that because the surveys are specifically designed surveys, the surveys can target a very specific list of insights desired by a company.

However, obtaining user perception via online surveys can be subject to limitation. For example, creating, administering, and analyzing surveys can be time consuming. Furthermore, survey results may be prone to response biases. While survey design may help to mitigate some issues, it can be difficult to eliminate types of response biases such as Demand Characteristics (i.e., when respondents alter their response simply because they are part of a study).

In addition, companies (e.g., enterprises, brands, organizations, and entities) may have thousands of products or hypotheses in their portfolio. It may be infeasible (and highly impractical) to create and conduct a survey for each product in the portfolio of products. Another limitation is that surveys cannot provide historical data if a survey was not administered during a particular relevant time period, e.g., a past time period of interest. For example, if a company was interested in user perception for a product in 2018 Q3, but had not created and conducted a survey for the product in 2018 Q3, the company will have no historical data to analyze or with which to compare against current insights. Yet another limitation is that surveys may be designed for a specific set of insights via a specific set of questions, which can result in missing certain insights based on questions which were not included the survey.

Thus, while surveys can provide user perception regarding products or other items, some challenges remain in effectively and efficiently obtaining the user perception, and, as a result, in modifying or designing future products based on the user perception.

The embodiments described herein provide a system which addresses these challenges by using readily available unstructured data, such as reviews of products or other items. The system uses Natural Language Processing (NLP)/Natural Language Understanding (NLU) to extract insights from reviews across various features or aspects of a product, which can result in an automatic, unstructured data insights toolkit.

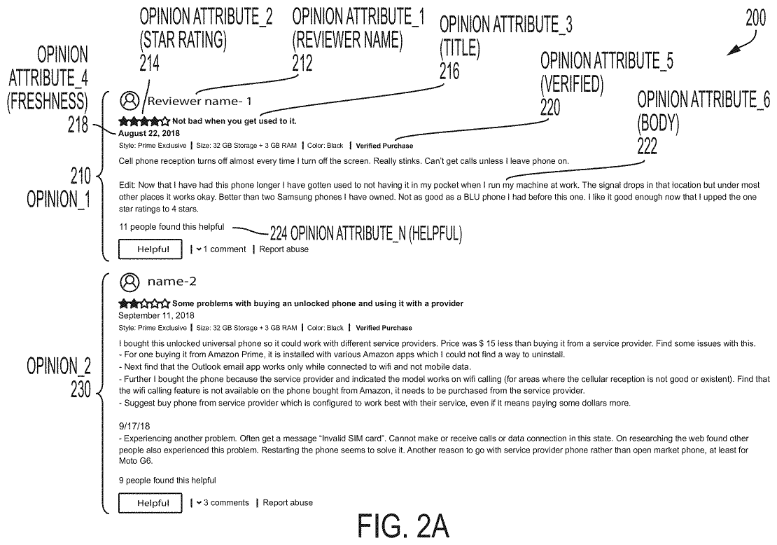

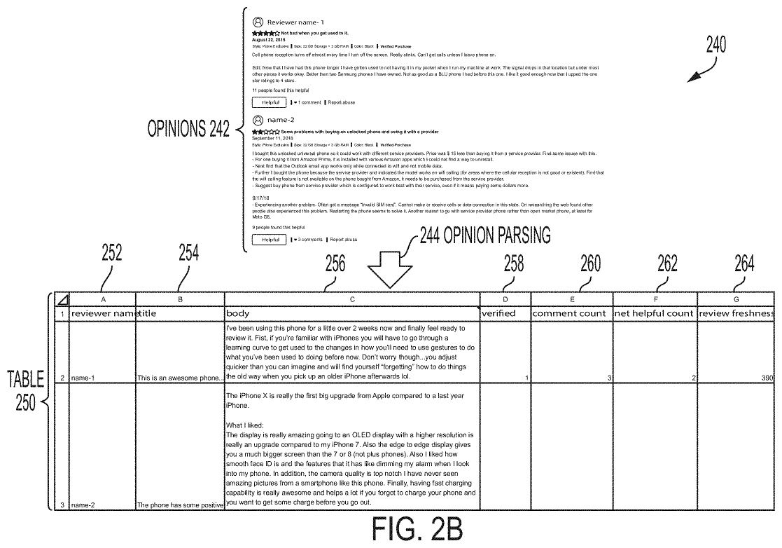

The system can include several modules, which can depend upon each other in various ways. The system can include an opinion parsing module, which takes as input reviews (i.e., reviewer opinions) of a product as a stream of data, and parses the opinion into attributes, such as the date, the title, the name of the reviewer, the rating, etc. The opinion parsing module provides as output a table, with rows indicating opinions and columns representing opinion attributes, as described below in relation to FIGS. 2A and 2B.

The system can gather user input information via at least three different modules: an opinion type setup module; an opinion calibration module;

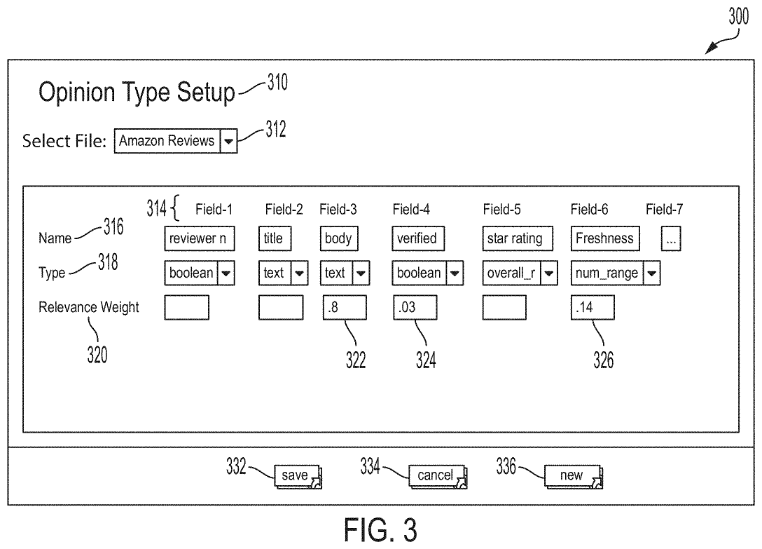

and an aspect entry module. Each source type for a review can have a different set of opinion attributes. The opinion type setup module can allow the user to specify the data format of a specific source (e.g., an Amazon or a Yelp review). The system also allows the user to assign a relevance weighting to each opinion attribute, as described below in relation to FIG. 3.

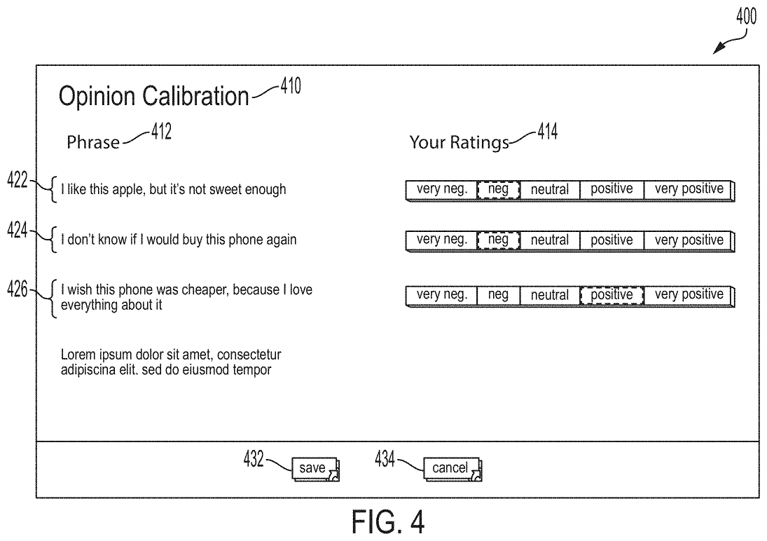

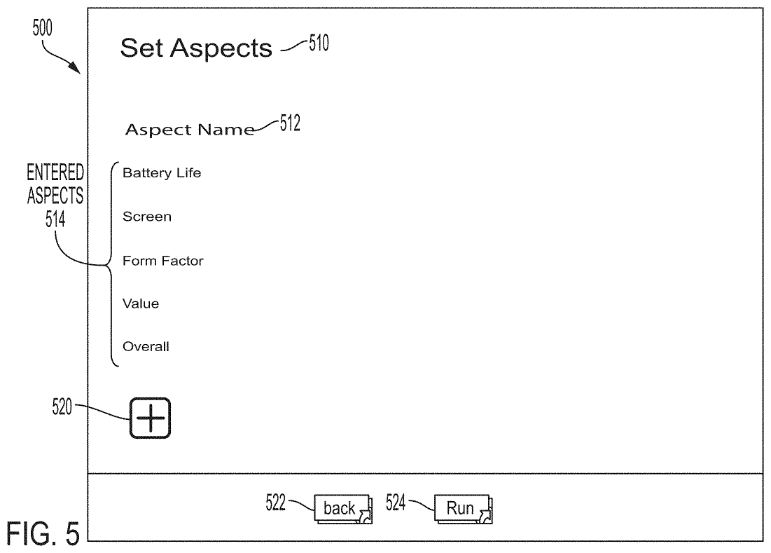

An opinion reviewer and a user of the system may have a different view on whether a specific opinion is positive or negative. The opinion calibration module can allow the user to rate a set of predetermined phrases or statements, as described below in relation to FIG. 4. The user may also specifically identify desired feature information as a list of terms of interest which appear in the reviews. The aspect entry module can allow the user to enter the desired feature information as terms of interest. The system can also automatically identify dominant terms or aspects in the reviews, which can be modified by the user to refine the results, as described below in relation to FIG. 5.

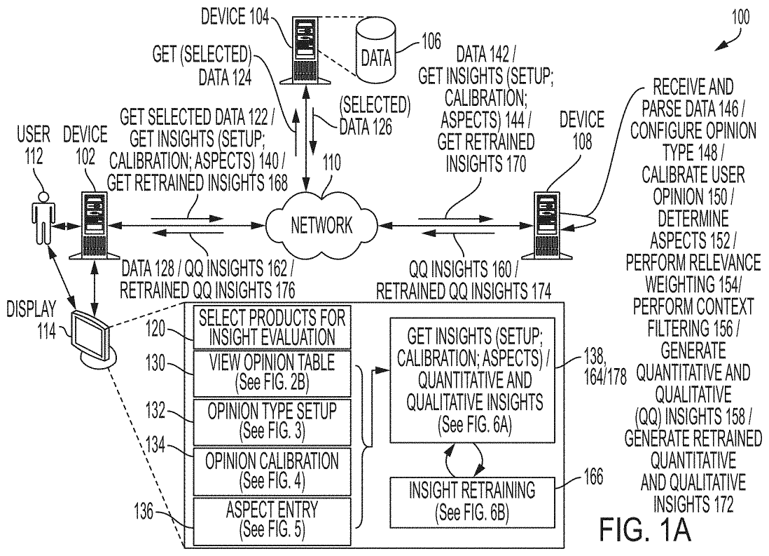

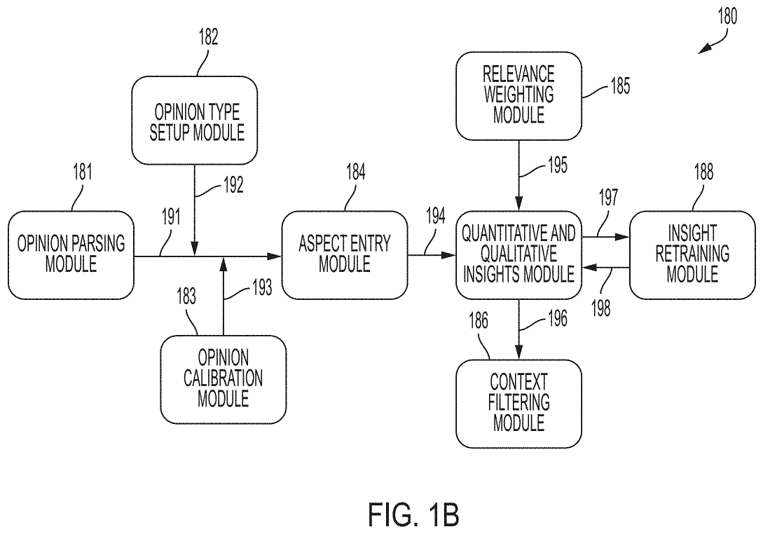

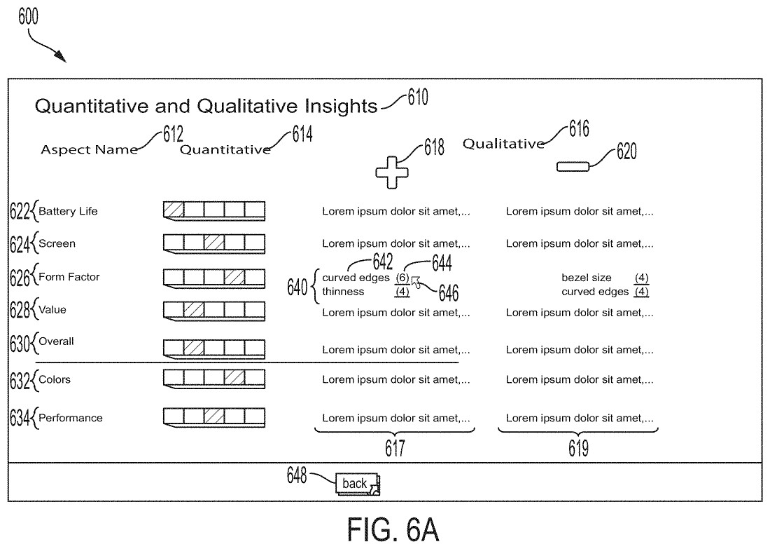

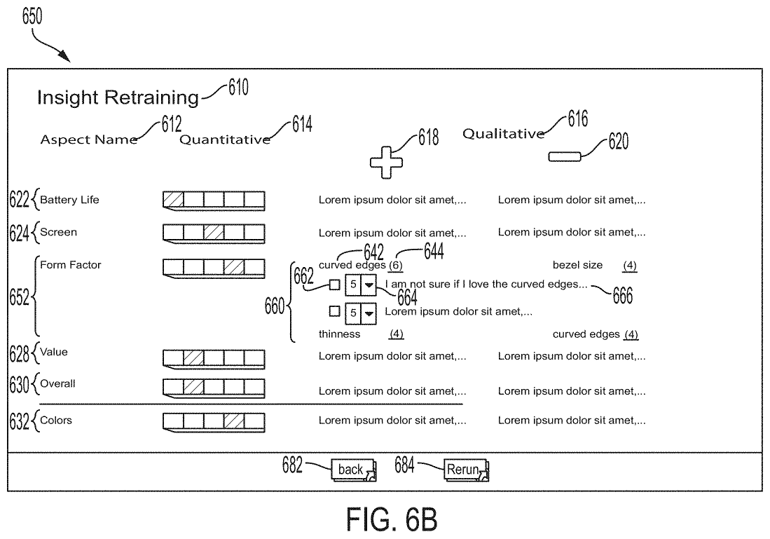

Based on the user-input information, the system can assign a normalized relevance weight for each review (by a relevance weighting module) and filter the reviews based on context (by a context filtering module), as described below in relation to FIGS. 1B, 3, and 6A. The system can subsequently generate quantitative and qualitative insights for the filtered reviews, which can be displayed as interactive graphical user elements on a display screen of a computing device associated with the user, as described below in relation to FIGS. 1A and 6B. In addition, the system allows the user retrain the system by modifying a rating of an insight displayed as a qualitative insight term, as described below in relation to FIGS. 1A and 6B.

Thus, the embodiments described herein provide an automatic, unstructured data insights toolkit by training a model to provide both quantitative and qualitative insights into user perception for a product, which eliminates the need for creating, conducting, and analyzing surveys (whether online or not), by using readily available reviews (i.e., reviewer opinions) for the product. The user can further train the model by modifying ratings for qualitative insights, which can cause the system to execute the trained model based on the modified ratings, which can result in an improvement in the machine learning process.

The terms “aspect,” “feature,” and “term of interest” are used interchangeably in this disclosure, and refer to a term or phrase which the user may be interested in. The user can manually enter the aspect, e.g., via the free-form “aspect entry” described below in relation to FIG. 5, and the system can also automatically identify additional feature information which is not included in the user-input terms of interest, as described below in the section titled “Algorithms for Automatic Aspect Detection.”

The term “quantitative insight” refers to an insight which is extracted from a set of data, such as reviews for a product or other item, and can be indicated on a display screen as a numerical or other fixed rating.

The term “qualitative insight” refers to an insight which is extracted from a set of data, such as reviews for a product or other item, and can be indicated on a display screen as a first set of positive terms and a second set of negative terms.

The term “relevance weighting” refers to a weight manually assigned by a user to one or more attributes of an opinion. The term “normalized relevance weighting” refers to a weight which is determined and calculated by the system based on the assigned relevance weightings and ranges for a particular attribute, as described below in the section titled “Relevance Weighting and Context Filtering.”

The term “reviewer” refers to a person who is using or has used, e.g., a product, or who is providing an opinion of, e.g., the product. The term “review” or “reviewer opinion” refers to opinion data written by the reviewer.

The term “opinion” refers to the basis for the review, which includes the physical manifestation of the reviewer opinion in the form of text and other opinion attributes. A review may be associated with a product, service, trip, package, tour, restaurant, shop, residence, hotel or other type of accommodation or lodging, a venue, or other item for which a reviewer may provide a review.

The term “user of the system” refers to a user who interacts with the described embodiments of the automatic, unstructured data insights toolkit, e.g., by inputting information regarding opinion type setup, opinion calibration, and aspect entry, and by modifying a rating of a displayed qualitative insight term. The term “user input” refers to data or information entered by a user of the system.

The term “opinion type setup” refers to the configuration by the user of the system, of the metadata associated with a review from a given site or associated with a type of product or other item.

The term “opinion calibration” refers to obtaining user input regarding a rating (i.e., a user opinion) on a set of predetermined phrases, and adjusting the system to account for the user-input ratings.

The words “interface,” “display,” and “display screen” are used interchangeably in this disclosure, and refer to information which is displayed on a display screen and which includes interactive graphical user interface (GUI) elements that allow the user to interact with the system and, e.g., retrain the model (via the insight retraining described below in relation to FIGS. 6A and 6B).

The terms “described embodiments,” “described system,” and “model” are used interchangeably in this disclosure, and refer to the system which includes the modules as described below in relation to FIG. 1B, and also includes the model (and retrained model) which uses the algorithms described herein.

### Exemplary Environment for Extracting Insights Related to Product Reviews

FIG. 1A illustrates an exemplary environment 100 for facilitating insight extraction, in accordance with an embodiment of the present application. Environment 100 can include: a device 102, an associated user 112, and an associated display 114; a device 104 and an associated storage device 106; and a device 108. Devices 102, 104, and 108 can communicate with each other via a network 110. Device 104 can obtain from other networked entities (not shown) and store on storage device 106, e.g., reviews from various websites of companies, brands, products, and other items. Devices 102, 104, and 108 can be a server, a computing device, or any device which can perform the functions described herein.

During operation, user 112 can determine, via display 114 and device 102, to obtain insights relating to a specific product or products, by obtaining or selecting the relevant data. For example, device 102 can display on display 114 a select products for insight evaluation 120 screen, which can include various companies and products for selection via graphical user interface elements, e.g., via input controls such as checkboxes, drop-down lists, and text fields, or via navigational components such as search fields, breadcrumbs, or icons (not shown). Device 102 can send a get selected data 122 command to device 104. Device 104 can receive get selected data 122 command (as a get (selected) data 124 command), and return (selected) data 126 to device 102. Device 102 can receive data 126 (as data 128), and can display on display 114 a view opinion table 130 screen. An exemplary opinion table is described below in relation to FIGS. 2A and 2B.

Device 102, via user 112, can determine to obtain insights relating to the selected data. Device 102 can send a get insights 140 command to device 108. Command 140 can include information input by the user, such as opinion type setup information, calibration information, and aspect entry information. For example, prior to or as part of sending get insights 140 command, device 102 can display on display 114 an opinion type setup 132 screen (as in FIG. 3), which allows the user to enter attribute information for opinion types from different data sources. Device 102 can also display on display 114 an opinion calibration 134 screen (as in FIG. 4), which allows the user to provide ratings of predetermined phrases. Device 102 can also display on display 114 an aspect entry 136 screen (as in FIG. 5), which allows the user to enter desired feature information. Device 102 can send get insights 140 command, along with the user input information from screens 130, 132, and 134, to device 108, e.g., by selecting on display 114 a get insights 138 graphical user interface element.

Device 108 can receive get insights 140 command (as a get insights 144 command). Device 108 can perform a receive and parse data 146 operation (which data can be obtained as data 142 from (selected) data 126), which generates an opinion table which can be returned (not shown) to device 102 to be displayed on 114 as view opinion table 130 screen. Based on either get insights 140 commands or on specific user commands sent via screens 132, 134, and 136, device can perform, respectively, the following operations: a configure opinion type 148 operation; a calibrate user opinion 150 operation; and a determine aspects 152 operation. Exemplary algorithms for operations 146-152 are described below in relation to FIGS. 2A, 2B, 3, 4, and 5.

Subsequently, device 108 can perform relevance weighting (operation 154) based on a relevance weight for attributes assigned by the user via opinion type setup screen 132 to obtain a normalized relevance weight for each review. Device 108 can also perform context filtering (operation 156) of the reviews, and remove the reviews deemed to be irrelevant to the context of get insights command 140. Device 108 can generate, by a trained model and based on the user-input information and the normalized relevance weight, quantitative and qualitative (QQ) insights (operation 158) for the filtered reviews. Device 108 can return QQ insights 160 to device 102.

Device 102 can receive QQ insights 160 (as QQ insights 162), and can display on display 114 a quantitative and qualitative insights 164 screen (as in FIG. 6A). User 112 can review the displayed QQ insights (which can include both quantitative insights based on a rating system and qualitative insights categorized as either positive or negative insight terms), and can modify a rating for a displayed qualitative insight term, e.g., via an insight retraining 166 screen (as in FIG. 6B). User 112 can rerun the trained model by generating and sending to device 108 a get retrained insights 168 command.

Device 108 can receive retrained insights 168 command (as a get retrained insights 170 command), and execute the trained model based on the modified rating, i.e., by generating retrained quantitative and qualitative insights (operation 172). Device 108 can return retrained QQ insights 174 to device 102. Device 102 can receive retrained QQ insights 174 (as retrained QQ insights 176), and can display on display 114 a quantitative and qualitative insights 178 screen (as in FIG. 6A).

Thus, environment 100 depicts an automatic, unstructured data insights toolkit which eliminates the need for online surveys. The toolkit can be part of a system which allows the user to provide customized user input information (e.g., opinion type setup, opinion calibration, and aspect entry via, respectively, screens 130, 132, and 134), where the system further performs relevance weighting based on both user-input relevance weights for opinion attributes and context filtering. The system can also include a trained model, which can be further trained based on user modification of qualitative insight terms and as described herein.

FIG. 1B illustrates an exemplary environment 180 for facilitating insight extraction, in accordance with an embodiment of the present application. Environment 180 can include an opinion parsing module 181, which parses selected data consisting of, e.g., online user reviews, as a stream of text data.

Environment 180 can include an opinion type setup module 182, which allows the user to assign a relevance weighting to each opinion attribute, as described below in relation to FIG. 3. Environment 180 can also include an opinion calibration module 183, which allows the user to rate a set of predetermined phrases or statements, as described below in relation to FIG. 4. Environment 180 can also include an aspect entry module 184, which allows the user to enter the desired feature information as terms of interest, and which can further automatically identify dominant terms or aspects in the reviews, as described below in relation to FIG. 5.

Environment 180 can further include a relevance weighting module 185 (which assigns a normalized relevance weight for each review) and a context filtering module 186 (which filters and removes reviews based on context), as described below in relation to FIGS. 3 and 6A.

Environment 180 can also include a quantitative and qualitative insights module 187, which can take as input information from modules 181, 182, 183, and 184 (via, respectively, communications 191, 192, 193, and 194), as well as information from modules 185 and 186 (via, respectively, communication 195, and 196). Quantitative and qualitative insights module 187 can generate quantitative and qualitative insights for the filtered reviews. These insights can be displayed as interactive graphical user elements on a display screen of a computing device associated with the user, as described above in relation to FIG. 1A and below in relation to FIG. 6B. Environment 180 can also include an insight retraining module 188 which receives information from module 187 (via a communication 197) and allows the user retrain the system by modifying a rating of an insight displayed as a qualitative insight term (via a communication 198), as described below in relation to FIG. 6B.

Thus, quantitative and qualitative module 187 and insight retraining module 188 can work together as part of a human-in-the-loop feedback loop which allows the user to train the model further based on customized user input.

Environment 180 can comprise an apparatus with units or modules configured to perform the operations described herein. The modules of environment 180 can be implemented as any combination of one or more modules of an apparatus, computing device, trained model, or other entity.

5

### Opinion Parsing

FIG. 2A illustrates exemplary reviews 200 for a product, including opinion attributes to be used in an opinion parsing module, in accordance with an embodiment of the present application. Reviews 200 can include an opinion_1 210 and an opinion_2 230. Each opinion can include various attributes, e.g.: an opinion attribute_1 (reviewer name) 212, which indicates the name of the reviewer; an opinion attribute_2 (star rating) 214, which indicates a number of stars rated and a total number of stars possible; an opinion attribute_3 (title), which indicates the title of the review or opinion; an opinion attribute_4 (freshness) 218, which indicates how recent or fresh the review is, based on a date of creation or modification of the review; an opinion attribute_5 (verified) 220, which indicates whether the user is a verified user or whether the purchase is a verified purchase; an opinion attribute_6 (body) 222, which indicates the body of the review; and an opinion attribute_N (helpful) 224, which indicates a number of people who found the review helpful.

FIG. 2B illustrates an exemplary process 240 for opinion parsing, in accordance with an embodiment of the present application. Process 240 can include opinions 242 (which can be similar to exemplary reviews 200 of FIG. 2A), which is read as a stream of data. Process 240 can include an opinion parsing 244 operation, which results in the creation of a table 250 based on the stream of data parsed from opinions 242. In table 250, each row can indicate a reviewer opinion, and each column can indicate an attribute of the reviewer opinion. For example: a column 252 can indicate the opinion attribute of the reviewer name; a column 254 can indicate the opinion attribute of the title; a column 256 can indicate the opinion attribute of the body; a column 258 can indicate the opinion attribute of verified; a column 260 can indicate an opinion attribute of a comment count; a column 262 can indicate an opinion attribute of net helpful count; and a column 264 can indicate an opinion attribute of the review freshness. Note that the opinion attributes depicted in FIGS. 2A and 2B may not match, and are depicted for exemplary purposes only. Fewer, more, or different opinion attributes may be used, or configured by the user, as described below in relation to FIG. 3.

### Opinion Type Setup and Assignments of Relevance Weights

FIG. 3 illustrates an exemplary graphical user interface 300 for an opinion type setup, in accordance with an embodiment of the present application. Interface 300 can include a title of the screen, as “Opinion Type Setup” 310 and a drop-down selection list 312, as “Select File” with an exemplary “Amazon Reviews” selected in drop-down selection list 312. Other selectable files may include organizations, sites, or companies which provide reviews on, e.g., products, services, restaurants, hotels, inns, locations, venues, tour companies, cruise lines/ships, vacation packages, and private property rentals. Once the user has selected the file for configuration, the user can enter a name 316 and a type 318 for each of fields 314 for the selected file. Each field can correspond to an opinion attribute. For example: a Field-1 can correspond to a name of “reviewer name” and a type of “Boolean”; a Field-2 can correspond to a name of “title” and a type of “text”; a Field-3 can correspond to a name of “body” and a type of “text”; Field-4 can correspond to a name of “verified” and a type of “Boolean”; Field-5 can correspond to a name of “star rating” and a type of “overall rating”; Field-6 can correspond to a name of “freshness” and a type of “number range.”

The user can also assign a relevance weight 320 to each field or opinion attribute. The total of the assigned relevance weights for a given file across all fields or opinion attributes should total “1.” Interface 300 depicts that the user assigns a relevance weight 322 of “0.8” to the “body” Field-3, a relevance weight 324 of “0.03” to the “verified” Field-4, and a relevance weight 326 of “0.14” to the “freshness” Field-6.

If the users clicks on a “Save” 332 button and the sum of the user-assigned relevance weights is not equal to 1, the system may display a dialog box notifying the user that the relevance weights do not add up to 1, which can force the user to exit the dialog box and fix the relevance weights until they add up to 1.

If the user clicks on the “Save” 322 button and the sum of the user-assigned relevance weights is equal to 1, the configured information on interface 300 can be sent to the system to be saved. The user can also click on a “Cancel” 334 button to cancel out of the Opinion Type Setup 310 interface, and can also click on a “New” 336 button to create a new file for a new source type and associated opinion attributes. In some embodiments, the system can include a set of default files and associated default opinion attributes, e.g., for popular or frequently accessed review sites like Amazon, Yelp, TripAdvisor, or Airbnb.

### Opinion Calibration

FIG. 4 illustrates an exemplary graphical user interface 400 for an opinion calibration, in accordance with an embodiment of the present application. Interface 400 can include a title of the screen, as “Opinion Calibration” 410 and a plurality of rows with a predetermined phrase 412 and an associated rating mechanism titled “Your Ratings” 414. For each predetermined phrase, different users may have a different view on whether their opinion of the predetermined phrase is positive or negative (or very negative, very positive, or neutral).

For example, in row 422, for the predetermined phrase of “I like this apple, but it's not sweet enough,” the user can decide that, in the opinion of the user, this phrase is a negative phrase. The user can select the “Negative” rating for the predetermined phrase of entry 422. Similarly, in row 424, for the predetermined phrase of “I don't know if I would buy this phone again,” the user can select a “Negative” rating, and in row 426, for the predetermined phrase of “I wish this phone was cheaper, because I love everything about it,” the user can select a “Positive” rating.

The user can click on a “Cancel” 434 button to cancel out of the Opinion Calibration, and return to a home page or prior screen. The user can click on a “Save” 432 button, which can send the configured ratings and calibration information on interface 400 to the system to be saved.

Interface 400 thus allows users to customize the requested insights by indicating their views on the list of predetermined phrases. Based on the user's ratings, the system can calibrate the insights model to reflect the user's views, rather than forcing users to adapt to a single view. Specifically, as part of opinion calibration module 183 of FIG. 1B, the system can adjust a threshold and scale of sentiment specific to the user by fine-tuning a subset of parameters in a final layer of the trained model based on new labeled examples.

### Aspect Entry: Free-Form and Automatic Detection

FIG. 5 illustrates an exemplary graphical user interface 500 for aspect entry, in accordance with an embodiment of the present application. Interface 500 can include a title of the screen, as “Set Aspects” 510 and a list of aspects indicated by an “Aspect Name” 512. For example, interface 500 can include the following entered aspects 514 (as entered by the user): Battery Life; Screen; Form Factor; Value; and Overall. The user can also click on a Add button 520 (indicated with a “+”) to add or enter a new aspect name. The user may enter a new aspect name by selecting from a prepopulated list or by entering an aspect name in a text entry field (not shown). This “free-form” aspect entry can be saved via a “Save” or “Accept” or “Return” button associated with the prepopulated list or the text entry field (not shown).

The user can click on a “Back” 522 button to go back to a prior screen, or the user can click on a “Run” 524 button, which sends all the configured user-input information from interfaces 300, 400, and 500 to the system, to perform relevance weighting and context filtering (as described above in relation to FIG. 1B).

In addition to the free-form aspect entry, the system can also automatically detect dominant aspects in the data set. This automatic aspect detection can be implemented using a human-in-the-loop approach. For example, the system can identify clusters and provide a suggested aspect name, and the user can tune, change, accept, or reject the names to refine the results.

Algorithms for Automatic Aspect Detection

The system can use an aspect-based sentiment detection algorithm for aspects which are entered by the user as feature information, and can use an aspect discovery mechanism to automatically discover aspects (e.g., feature information or terms of interest) which are not specified by the user.

The aspect-based sentiment detection algorithm can be used to detect a “mention” or “occurrence” (e.g., “square edges”) of aspects specified by the user (e.g., “form factor”) and a sentiment associated with the mention (e.g., “negative” or a rating or “2/5”). This algorithm can take as input the aspect name (e.g., “consistency”), optional aspect terms (e.g., “creamy”), and review text, and can provide as output predicted aspect mentions or occurrences and the associated sentiment.

This algorithm can be based on a Bidirectional Encoder Representations from Transformers (BERT)-Large or other pretrained sequence model with two additional layers. The first additional layer can include an aspect mention detection layer, which is a sequence labeling and classification layer that assigns tags (e.g., inside-outside-beginning (BIO) tags) identifying mentions or occurrences of terms. The second layer can include a sentiment detection layer, which is a token or span-level classifier or regression model that predicts a sentiment associated with a mention or occurrence of a term. As described above, the model can take as input the text, the aspect name, and optional aspect terms. The system can use a training or test dataset which includes a list of <aspect name, aspect terms (optional), review text>tuples which are labeled with mention spans and an associated sentiment. The system does not require training data for a specific aspect name, domain, etc., which eliminates the need for any customer-specific annotation. In addition, the system can create a validation/test split by using data from domains which are not seen in the training set in order to optimize the model for cross-domain generalization (e.g., through a hyperparameter search).

The aspect discovery mechanism to automatically discover aspects not specified by the user can include training an aspect-independent version of the model, where the aspect-independent version does not include an aspect name (or a feature name) as an input feature. The system can predict, based on the aspect-independent version of the model, aspect mentions (e.g., occurrences of terms in reviews). The system can also identify, based on the aspect-independent version of the model, aspect mentions (e.g., occurrences of terms) which are not predicted by the aspect-specific version of the model (e.g., as in the aspect-based sentiment detection algorithm) as candidate aspects (or terms) for discovery. The system can cluster the BERT (or other) embeddings of these identified aspect mentions based on a K-means or other clustering algorithm, and can also generate candidate labels for the cluster based on words which have the closest embedding to the centroid of the cluster.

### Relevance Weighting and Context Filtering

The system can mimic how humans may typically derive insights from opinion sets (e.g., data sets of reviews for a product or other item). For example, given a set of reviews for a specific cell phone, humans may generally place a higher relevance on more recent reviews, and may place a lower relevance on less recent reviews. Similarly, humans may generally place a higher relevance on reviews which are provided by buyers that have been verified by the corresponding platform (e.g., a “verified buyer”), and may place a lower relevance on reviews which are provided by buyers that are not verified buyers.

The system can address these relevance assignments by performing relevance weighting. The system allows the user to assign a relevance weight for one or more attributes of an opinion, as depicted by relevance weight 320 for fields 314 of Opinion Type Setup 310 display of interface 300. As described above, the sum of the assigned relevance weights should add to 1, and the system can notify the user via various widgets (e.g., a dialog box which pops up and requires the user to click a button, or an error message which can be closed by the user) if the user attempts to save a particular opinion type setup where the sum of the assigned relevance weights does not add up to 1.

In addition to allowing the user to assign a relevance weight for one or more attributes of an opinion via the opinion type setup screen or interface, the system can also normalize the data as required. For example, a “Date of Review” attribute (e.g., depicted as “Freshness” in FIGS. 2A, 2B, and 3) can indicate how recent the review is, or its level of “freshness.” A review may be, e.g., one day old, ten days old, 100 days old, or 200 days old. Given these arbitrary number ranges, the system can normalize the range before applying the weights and calculating the relevance.

The system can also narrow down a set of reviews/opinions by performing context filtering. Not all reviews/opinions in an opinion set may be relevant to a particular analysis. For example, in a set of reviews for a specific cell phone, some of the reviews may not address the cell phone itself, but instead may address issues with customer service, shipping, communications from the shipping company, delivery, etc. The system can use the opinions in the opinion data set to build a context understanding, and can subsequently filter out reviews which are out of context, e.g., which do not align with the context understanding as learned by the model.

Specifically, the system can train the model, which can be a BERT-Large or other pretrained model with a binary classification head, to determine whether a review is relevant or not. The task of the model can be treated as a binary classification task (e.g., relevant or not relevant), where the training procedure can improve generalization across domains. The system can use a training or test dataset which includes reviews over diverse sets of domains, products, and platforms, and which can be labeled as relevant or not relevant. In addition, the system can create a validation/test split by using data from domains which are not seen in the training set in order to optimize the model for cross-domain generalization (e.g., through a hyperparameter search), as described above in the section titled “Algorithms for Automatic Aspect Detection.”

### Generation and Display of Quantitative and Qualitative Insights

FIG. 6A illustrates an exemplary graphical user interface 600 which displays quantitative and qualitative insights for reviews for a product, including interactive graphical user interface elements, in accordance with an embodiment of the present application. Interface 600 can include a title of the screen, as “Quantitative and Qualitative Insights” 610 and a list of aspects indicated by an “Aspect Name” 612 with corresponding “Quantitative Insights” 614 and “Qualitative Insights” 616. Quantitative Insights 614 can indicate an aggregate score for the corresponding aspect based on a rating system. The system can generate quantitative insights 614 by computing an aggregate sentiment score for each term or aspect based on the user-input relevance weight for the attribute across the reviews.

Qualitative Insights 616 can be split into two columns: positive qualitative insights 617 can be indicated under the column marked with a “+” 618 visual indicator; and negative qualitative insights 619 can be indicated under the column marked with a “−” 620 visual indicator. The system can also identify the most relevant (e.g., most frequently occurring) positive and negative comments about each aspect, and can use NLP to display a concise summary of the comments. The system can also display a drill-down option by indicating the number of opinions for each positive or negative comment.

For example, in a row 622 for the aspect “Battery Life,” interface 600 can display quantitative insights 614 based on a rating system. While the blocks which depict the quantitative insight rating are not labeled, they can correspond to, e.g., the rating system depicted in interface 400 of FIG. 4, where the rating system proceeds from the most negative on the left side to the most positive on the right side. In other words, one possible order for the rating system indicated by the blocks of quantitative insights 614 can be: Very Negative;

Negative; Neutral; Positive; and Very Positive. Thus, in row 622, the quantitative insights 614 for the aspect “Battery Life” across all the reviews considered and analyzed is assigned a final score of “Very Negative,” e.g., the left most block is shaded and indicates a quantitative insight rating of “Very Negative.”

As another example, in a row 626 for the aspect “Form Factor,” interface 600 can display quantitative insights 614, which indicate a rating of, e.g., Positive, based on the second from the right shaded box. In row 626, interface 600 can display qualitative insights 616 as positive comments 617 and negative comments 619 (indicated as positive and negative comments 640). In positive and negative comments 640, positive qualitative insights 617 can include “curved edges” and “thinness” as terms which are displayed because the system has identified these terms as the most relevant (e.g., the most frequently mentioned) positive comments about the aspect “Form Factor.” Similarly, negative qualitative insights 619 can include “bezel size” and “curved edges” as terms which are displayed because the system has identified these terms as the most relevant or frequently mentioned negative comments about the aspect “Form Factor.”

Each positive and negative comment can include a count which follows the comment, where the count corresponds to the number of times that the positive or negative comment was included in a review. For example, the positive comment “curved edges” 642 appeared six times in the reviews for the product, and is indicated with a number “6” 644 following the positive comment. The user can click on the area near or associated with the number “6” (e.g., in an area 646), which can result in a screen which displays a list of the comments (e.g., the phrases) as they appear in an original comment. This detail can provide additional context for the user.

In some embodiments, when the user clicks on area 646, the system can display an interface such as the Insight Retraining screen depicted below in relation to FIG. 6B. The user can also click on a “Back” 648 button, which can bring the user back to any prior screen or interface, e.g., interfaces 300, 400, or 500 of, respectively, FIGS. 3, 4, and 5, or to a home, starting, or other initial page (not shown).

In the qualitative analysis, in order to generate qualitative insights 616, the system can aggregate occurrences or mentions of the terms (e.g., sharp corners (5)) and the sentiments associated with the terms (e.g., negative), by computing a first count of a number of occurrences of a term categorized as a positive insight and a second count of a number of occurrences of terms categorized as a negative insight. The system can compute these counts based on the user-input relevance weight for the attribute across the reviews.

### Insight Retraining

FIG. 6B illustrates an exemplary graphical user interface 650 which displays quantitative and qualitative insights for reviews for a product, including interactive graphical user interface elements which allow the user to override system-determined ratings and to rerun the model, in accordance with an embodiment of the present application. Interface 650 displays information similar to the information displayed on interface 600, and interface 650 can be displayed after the user clicks on an area associated with a positive or a negative comment. For example, if the user clicks on area 646 associated with the number “6” 644 of positive comment “curved edges” 642, the system can display interface 650.

Interface 650 can include a title of the screen, as “Insight Retraining” 610. Interface 650 can include an expanded view of the positive and negative comments included in the reviews. For example, in a row 652 for the aspect name “Form Factor,” an expanded view 660 can include detailed information associated with positive comments for positive qualitative insight “curved edges” 642, which is a term or attribute that appears “6” 644 times in the reviews for the product. The detailed information can include interactive user interface elements such as a checkbox and a drop-down list, as well as the phrase, sentence, or context in which the term or attribute appears in the reviews. For example, for the positive term “curved edges,” the system can display on interface 650 a checkbox 662, a drop-down list 664, and phrase or sentence “I am not sure if I love the curved edges . . . ” 666. Drop-down list 664 can display the rating assigned by the system to this attribute. The user can decide to modify the assigned rating, and select a different number or rating from drop-down list 664. The user can then select checkbox 662, or the system can automatically select checkbox 662 when detecting a change to drop-down list 664. The user can modify one or more ratings using interface 650, and subsequently can click on a “Rerun” 684 button, which causes the system to execute the trained model based on the modified rating(s). The user can also click on a “Back” 682 button to go back to a prior screen (similar to clicking on “Back” 648 button in interface 600).

The system can subsequently generate and display updated quantitative and qualitative insights for the filtered reviews, e.g., by displaying interface 600 based on the updated insights. This feedback loop between the user and the model is depicted above in relation to FIGS. 1A and 1B (e.g., communications 197 and 198). Thus, by allowing the user to drill down into each insight (positive or negative), the user may examine why the system arrived at a particular insight. If the user determines that a review was classified incorrectly (e.g., an incorrect quantitative rating), the user can manually override the rating for the review via the interactive user interface elements (e.g., 644, 662, 664, and 684), which triggers a retraining of the model. The model can learn from the user's manual override to adjust the analysis and provided updated quantitative and qualitative insights. The model of the system can therefore be retrained based on corrections to the model predictions, e.g., by fine-tuning the existing model based on corrected labels.

### Method for Extracting Insights Related to Product Reviews

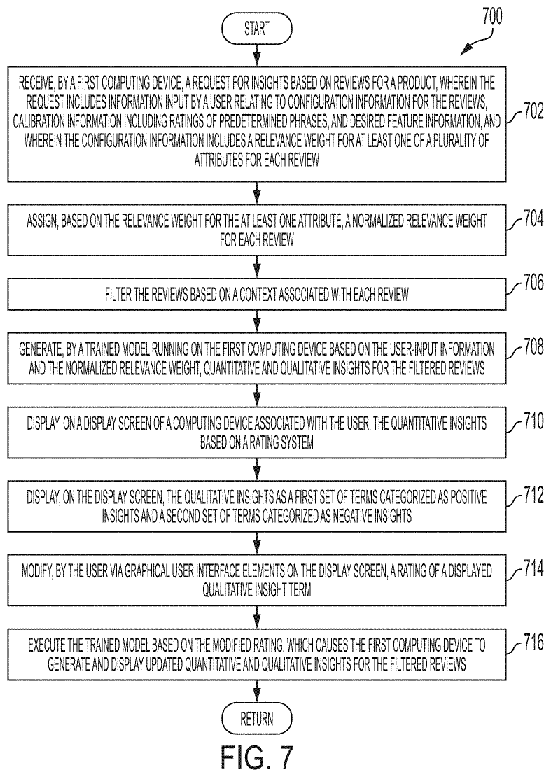

FIG. 7 presents a flow chart 700 illustrating a method for extracting insights associated with reviews for a product, in accordance with an embodiment of the present application. During operation, the system receives, by a first computing device, a request for insights based on reviews for a product, wherein the request includes information input by a user relating to configuration information for the reviews, calibration information including ratings of predetermined phrases, and desired feature information, and wherein the configuration information includes a relevance weight for at least one of a plurality of attributes for each review (operation 702). The system assigns, based on the relevance weight for the at least one attribute, a normalized relevance weight for each review (operation 704). The system filters the reviews based on a context associated with each review (operation 706). The system generates, by a trained model running on the first computing device based on the user-input information and the normalized relevance weight, quantitative and qualitative insights for the filtered reviews (operation 708).

The system displays, on a display screen of a computing device associated with the user, the quantitative insights based on a rating system (operation 710). The system displays, on the display screen, the qualitative insights as a first set of terms categorized as positive insights and a second set of terms categorized as negative insights (operation 712). The system modifies, by the user via graphical user interface elements on the display screen, a rating of a displayed qualitative insight term (operation 714). The system executes the trained model based on the modified rating, which causes the first computing device to generate and display updated quantitative and qualitative insights for the filtered reviews (operation 716).

Summary of Application; Integration into a Practical Application; Improvements to Technical Fields

In summary, the embodiments described herein provide a system which uses readily available unstructured data (such as product reviews), and which extracts insights from the data (reviews) across various features or aspects of a product. The system allows for the ability to enter free-form aspects for aspect-level insights, and can provide domain-independent scalability of insight generation. The system also provides an opinion calibration evaluation specific to individual users of the system, and further provides the ability to extend analysis by supporting multiple data types requested by the user (e.g., via the opinion type setup and configuration of the description of metadata). Finally, the human-in-the-loop artificial intelligence model allows a user to manually override the model predictions and trigger an updated generation of insights, which allows the model to re-learn based on the manual overrides input by the user.

The embodiments described herein provide a system which can be integrated into a practical application, e.g., for market researchers and marketers of various brands or products. The described system is self-serving, as it allows marketing and product managers to execute a research process instantly, without any dependencies on other teams or vendors. The described system also addresses the issue of response bias inherent in prior methods (e.g., specifically designed surveys which are administered in a particular setting), as the system provides a form of analysis which can mitigate forms of responses biases such as Demand Characteristics and Acquiescence Bias.

The described system can also address the issue of lack of time adaptability, as the system can easily go back in time by using data from the past. The system can also flexibly analyze data for any desired period, interval, or window of time (of a total possible time range of all available reviews). Furthermore, the described system can address the issue of providing insufficient coverage for a large product portfolio. That is, the system can provide full product portfolio coverage, e.g., by easily creating an analysis for an entire product suite. This can allow the platform to execute efficiently and effectively while remaining independent of context and product-specific needs. Finally, the system can provide analysis heterogeneity. By allowing the user to set free-form aspects, a user of the system can design numerous analyses of the same data.

The described embodiments can also result in an improvement to the technical and technological fields of artificial intelligence, machine learning, data mining, insight generation from online reviews, and extraction of insights of user perception. By eliminating the need to create, distribute, conduct, compile, and analyze product-specific (and in some cases, demographic-specific) surveys, the described embodiments provide an improvement to the field of data analysis, and can further result in a more efficient method of data mining relating to a voluminous amount of reviewer-provided data from any desired number of sites relating to any products. While the described embodiments pertain to online reviews of products, the system can also work on any reviewer or product user opinions which can be collected and converted to a stream of data, and subsequently parsed by the system as described herein. For example, the reviews for a product can be collected manually, or via a non-networked system, and can be subsequently converted to a format which can be parsed by the opinion parsing module.

Exemplary users of the system can include enterprises which spend a large amount on market research (e.g., Proctor & Gamble, Unilever, Coca Cola, Pharma, Automobiles, etc.). Other exemplary users can include market research firms (e.g., Nielsen, Ipsos, Kantar, and NPD) as well as survey respondent aggregators (e.g., Qualtrics).

Thus, the improvements provided by the disclosed system apply to several technologies and technical fields, including but not limited to: artificial intelligence, machine learning, data mining, insight generation from online reviews, and extraction of insights of user perception, across multiple domains, user/reviewer demographics, products, and product portfolios.

### Exemplary Distributed Computer System

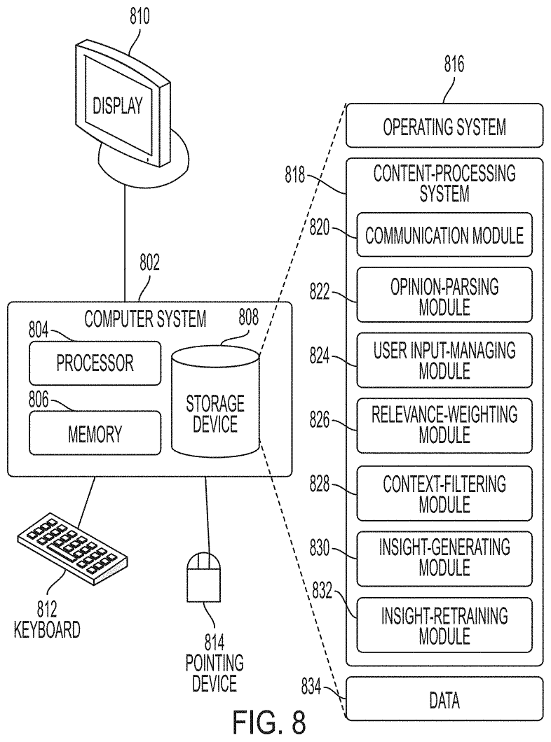

FIG. 8 illustrates an exemplary distributed computer and communication system 802 that facilitates insight extraction, in accordance with an embodiment of the present application. Computer system 802 includes a processor 804, a memory 806, and a storage device 808. Memory 806 can include a volatile memory (e.g., RAM) that serves as a managed memory, and can be used to store one or more memory pools. Furthermore, computer system 802 can be coupled to a display device 810, a keyboard 812, and a pointing device 814. Storage device 808 can store an operating system 816, a content-processing system 818, and data 834.

Content-processing system 818 can include instructions, which when executed by computer system 802, can cause computer system 802 to perform methods and/or processes described in this disclosure. Specifically, content-processing system 818 may include instructions for sending and/or receiving/obtaining data packets to/from other network nodes across a computer network (communication module 820). A data packet can include, e.g., a request, data, user input, opinion-related information, review-related information, a relevance weight, a modified rating, calibration information, etc.

Content-processing system 818 can further include instructions for receiving, by a first computing device, a request for insights based on reviews for a product, wherein the request includes information input by a user relating to configuration information for the reviews, calibration information including ratings of predetermined phrases, and desired feature information, and wherein the configuration information includes a relevance weight for at least one of a plurality of attributes for each review (communication module 820 and user input-managing module 824). Content-processing system 818 can include instructions for assigning, based on the relevance weight for the at least one attribute, a normalized relevance weight for each review (relevance-weighting module 826). Content-processing system 818 can include instructions for filtering the reviews based on a context associated with each review (context-filtering module 828). Content-processing system 818 can include instructions for generating, by a trained model running on the first computing device based on the user-input information and the normalized relevance weight, quantitative and qualitative insights for the filtered reviews (insight-generating module 830).

Content-processing system 818 can include instructions for displaying, on a display screen of a computing device associated with the user, the quantitative insights based on a rating system (insight-generating module 830). Content-processing system 818 can include instructions for displaying, on the display screen, the qualitative insights as a first set of terms categorized as positive insights and a second set of terms categorized as negative insights (insight-generating module 830). Content-processing system 818 can include instructions for modifying, by the user via graphical user interface elements on the display screen, a rating of a displayed qualitative insight term (user input-managing module 824). Content-processing system 818 can include instructions for executing the trained model based on the modified rating, which causes the first computing device to generate and display updated quantitative and qualitative insights for the filtered reviews (insight-retraining module 832).

In some embodiments, insight-generating module 830 can include a information-displaying sub-module (not shown) for displaying information on the display screen of the computing device associated with the user, as described above in relation to FIGS. 6A and 6B. For example, content-processing system 818 can include instructions for: displaying, on the display screen, graphical user interface elements which allow the user to enter, view, modify, and save the configuration information, wherein the configuration information includes the relevance weight for the at least one attribute for each review and further includes a name and a type for the plurality of attributes for each review; displaying, on the display screen, graphical user interface elements which allow the user to enter, view, modify, and save the calibration information, wherein the user-input ratings of the predetermined phrases are based on the rating system; and displaying, on the display screen, graphical user elements which allow the user to enter, view, modify, and save the desired feature information, wherein the desired feature information includes terms of interest in the reviews for the product (information-displaying sub-module).

Data 834 can include any data that is required as input or that is generated as output by the methods and/or processes described in this disclosure. Specifically, data 834 can store at least: a stream of data; parsed data; a table; a row which indicates a reviewer opinion; a column which indicates an opinion attribute; a request; an insight; user input; configuration information; calibration information; a predetermined phrase; a rating for a phrase; a rating system; feature information; an aspect; a term; a term of interest; a feature; an occurrence; a mention; a span; a number of occurrences or mentions of a term in a body of text; a review; a review for a product or other item; an attribute; an attribute of a review or an opinion; a relevance weight; a context associated with a review; a model; a trained model; a retrained model; a normalized relevance weight; a quantitative insight; a qualitative insight; a term categorized as a positive qualitative insight or a negative qualitative insight; a modified rating; updated quantitative and/or qualitative insights; an indicator of a graphical user interface (GUI) element; a user action associated with a GUI element; a BERT-large model; an aspect mention detection layer; a sequence labeling and classification layer; a tag; a sentiment detection layer; a token or span-level classifier or regression model; a prediction of a sentiment; additional feature information; an aspect-independent version of a model; a prediction of occurrences of terms; an identification of occurrences of terms not predicted by a trained model; a candidate term for discovery; a clustered embedding of terms; a threshold and scale of sentiment specific to a user; parameters in a final layer of a trained model; new labeled examples; filtered reviews; a determination of whether a review is relevant or not relevant; an aggregate sentiment score for a term; an aggregate occurrence of terms and sentiments in reviews; positive comments; positive qualitative insight terms; negative comments; negative qualitative insight terms; a first count of occurrences of positive insight terms; a second count of occurrences of negative insight terms; an expanded view; a drill-down view of positive or negative comments; a user-input relevance weight for attributes across reviews; a correction to a model prediction; and corrected labels.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described above can be included in hardware modules or apparatus. The hardware modules or apparatus can include, but are not limited to, application-specific integrated circuit (ASIC) chips, field-programmable gate arrays (FPGAs), dedicated or shared processors that execute a particular software module or a piece of code at a particular time, and other programmable-logic devices now known or later developed. When the hardware modules or apparatus are activated, they perform the methods and processes included within them.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A computer-implemented method, comprising:
receiving, by a first computing device, a request for insights based on reviews for a product, wherein the request includes information input by a user relating to configuration information for the reviews, calibration information including ratings of predetermined phrases, and desired feature information, and
wherein the configuration information includes a relevance weight for at least one of a plurality of attributes for each review;
assigning, based on the relevance weight for the at least one attribute, a normalized relevance weight for each review;
filtering the reviews based on a context associated with each review;
generating, by a trained model running on the first computing device based on the user-input information and the normalized relevance weight, quantitative and qualitative insights for the filtered reviews;
displaying, on a display screen of a computing device associated with the user, the quantitative insights based on a rating system;
displaying, on the display screen, the qualitative insights as a first set of terms categorized as positive insights and a second set of terms categorized as negative insights;
modifying, by the user via graphical user interface elements on the display screen, a rating of a displayed qualitative insight term; and
executing the trained model based on the modified rating, which causes the first computing device to generate and display updated quantitative and qualitative insights for the filtered reviews.

2. The method of claim 1, wherein prior to receiving the request for insights, the method further comprises:
receiving a stream of text data relating to the reviews for the product, wherein a review represents a reviewer opinion of the product; and
parsing the stream of text data to generate a table, wherein a row in the table indicates the reviewer opinion of the product, and wherein a column in the table indicates the attributes of the reviewer opinion.

3. The method of claim 1, wherein the user-input information is obtained by one or more of:
displaying, on the display screen, graphical user interface elements which allow the user to enter, view, modify, and save the configuration information,
wherein the configuration information includes the relevance weight for the at least one attribute for each review and further includes a name and a type for the plurality of attributes for each review;
displaying, on the display screen, graphical user interface elements which allow the user to enter, view, modify, and save the calibration information,
wherein the user-input ratings of the predetermined phrases are based on the rating system; and
displaying, on the display screen, graphical user elements which allow the user to enter, view, modify, and save the desired feature information,
wherein the desired feature information includes terms of interest in the reviews for the product.

4. The method of claim 3, wherein the trained model is a pretrained sequence model which includes two additional layers, including:
an aspect mention detection layer which comprises a sequence labeling and classification layer that assigns tags identifying occurrences of terms; and
a sentiment detection layer which comprises a token or span-level classifier or regression model that predicts a sentiment associated with an occurrence of a term.

5. The method of claim 4, wherein generating the quantitative and qualitative insights for the filtered reviews is further based on the user-input terms of interest, which comprises:
detecting, in a respective review based on the trained model, a first occurrence of a first term and a first sentiment associated with the first occurrence of the first term.

6. The method of claim 4, wherein generating the quantitative and qualitative insights for the filtered reviews is further based on additional feature information identified by the first computing device and not included in the user-input terms of interest, and wherein identifying the additional feature information comprises:
training an aspect-independent version of the model, wherein the aspect-independent version does not include a feature name as an input feature;
predicting, based on the aspect-independent version of the model, second occurrences of terms in reviews;
identifying, based on the aspect-independent version of the model, third occurrences of terms which are not predicted by the trained model as candidate terms for discovery; and
clustering embeddings of the identified third occurrences.

7. The method of claim 3, wherein generating the quantitative and qualitative insights for the filtered reviews is further based on the user-input calibration information, which comprises:
adjusting a threshold and a scale of sentiment specific to the user by fine-tuning a subset of parameters in a final layer of the trained model based on new labeled examples.

8. The method of claim 1, wherein filtering the reviews based on the context associated with each review further comprises:
determining, by the trained model, whether a review is relevant based on a binary classification.

9. The method of claim 1, wherein generating the quantitative insights for the filtered reviews comprises:
computing an aggregate sentiment score for each term based on the user-input relevance weight for the attributes across the reviews.

10. The method of claim 1, wherein generating the qualitative insights for the filtered reviews comprises:
aggregating occurrences of the terms in the filtered reviews and sentiments associated with the terms by:
computing a first count of a number of occurrences of a term categorized as a positive insight and a second count of a number of occurrences of a term categorized as a negative insight,
wherein computing the first count and the second count is based on the user-input relevance weight for the attributes across the reviews.

11. The method of claim 1, wherein executing the trained model based on the modified rating comprises:
training the model based on corrections to model predictions and corrected labels.

12. A computer system, the system comprising:
a processor; and
a storage device storing instructions that when executed by the processor cause the processor to perform a method, the method comprising:
receiving, by a first computing device, a request for insights based on reviews for a product, wherein the request includes information input by a user relating to configuration information for the reviews, calibration information including ratings of predetermined phrases, and desired feature information, and
wherein the configuration information includes a relevance weight for at least one of a plurality of attributes for each review;
assigning, based on the relevance weight for the at least one attribute, a normalized relevance weight for each review;
filtering the reviews based on a context associated with each review;
generating, by a trained model running on the first computing device based on the user-input information and the normalized relevance weight, quantitative and qualitative insights for the filtered reviews;
displaying, on a display screen of a computing device associated with the user, the quantitative insights based on a rating system;
displaying, on the display screen, the qualitative insights as a first set of terms categorized as positive insights and a second set of terms categorized as negative insights;
modifying, by the user via graphical user interface elements on the display screen, a rating of a displayed qualitative insight term; and
executing the trained model based on the modified rating, which causes the first computing device to generate and display updated quantitative and qualitative insights for the filtered reviews.

13. The computer system of claim 12, wherein prior to receiving the request for insights, the method further comprises:
receiving a stream of text data relating to the reviews for the product, wherein a review represents a reviewer opinion of the product; and
parsing the stream of text data to generate a table, wherein a row in the table indicates the reviewer opinion of the product, and wherein a column in the table indicates the attributes of the reviewer opinion.

14. The computer system of claim 12, wherein the user-input information is obtained by one or more of:
displaying, on the display screen, graphical user interface elements which allow the user to enter, view, modify, and save the configuration information,
wherein the configuration information includes the relevance weight for the at least one attribute for each review and further includes a name and a type for the plurality of attributes for each review;
displaying, on the display screen, graphical user interface elements which allow the user to enter, view, modify, and save the calibration information,
wherein the user-input ratings of the predetermined phrases are based on the rating system; and
displaying, on the display screen, graphical user elements which allow the user to enter, view, modify, and save the desired feature information,
wherein the desired feature information includes terms of interest in the reviews for the product.

15. The computer system of claim 14, wherein the trained model is a pretrained sequence model which includes two additional layers, including:
an aspect mention detection layer which comprises a sequence labeling and classification layer that assigns tags identifying occurrences of terms; and
a sentiment detection layer which comprises a token or span-level classifier or regression model that predicts a sentiment associated with an occurrence of a term.

16. The computer system of claim 15, wherein generating the quantitative and qualitative insights for the filtered reviews is further based on the user-input terms of interest, which comprises:
detecting, in a respective review based on the trained model, a first occurrence of a first term and a first sentiment associated with the first occurrence of the first term.

17. The computer system of claim 15, wherein generating the quantitative and qualitative insights for the filtered reviews is further based on additional feature information identified by the first computing device and not included in the user-input terms of interest, and wherein identifying the additional feature information comprises:
training an aspect-independent version of the model, wherein the aspect-independent version does not include a feature name as an input feature;
predicting, based on the aspect-independent version of the model, second occurrences of terms in reviews;
identifying, based on the aspect-independent version of the model, third occurrences of terms which are not predicted by the trained model as candidate terms for discovery; and
clustering embeddings of the identified third occurrences.

18. The computer system of claim 14, wherein generating the quantitative and qualitative insights for the filtered reviews is further based on the user-input calibration information, which comprises:
adjusting a threshold and a scale of sentiment specific to the user by fine-tuning a subset of parameters in a final layer of the trained model based on new labeled examples.

19. The computer system of claim 12,
wherein generating the quantitative insights for the filtered reviews comprises computing an aggregate sentiment score for each term based on the user-input relevance weight for the attributes across the reviews; and
wherein generating the qualitative insights for the filtered reviews comprises aggregating occurrences of the terms in the filtered reviews and sentiments associated with the terms by:
computing a first count of a number of occurrences of a term categorized as a positive insight and a second count of a number of occurrences of a term categorized as a negative insight,
wherein computing the first count and the second count is based on the user-input relevance weight for the attributes across the reviews.

20. The computer system of claim 12, wherein executing the trained model based on the modified rating comprises:
training the model based on corrections to model predictions and corrected labels.
